(19) United States
(12) Patent Application Publication
(10) Pub. No.: US 2012/0322653 A1
(43) Pub. Date: Dec. 20, 2012

(54) AQUEOUS CATALYST SULFIDING PROCESS

(75) Inventors: Kimberly Ann JOHNSON, Richmond, TX (US); Joseph Broun Powell, Houston, TX (US); John Anthony SMEGAL, Houston, TX (US)

(73) Assignee: SHELL OIL COMPANY, Houston, TX (US)

(21) Appl. No.: 13/495,749

(22) Filed: Jun. 13, 2012

Related U.S. Application Data
(60) Provisional application No. 61/496,649, filed on Jun. 14, 2011.

(51) Int. Cl. B01J 27/047; B01J 27/049; B01J 27/043; B01J 27/051; C01B 17/20; C01B 17/32

(52) U.S. Cl. 502/220; 423/512.1; 423/511; 423/560; 502/219; 502/222; 502/221

(57) ABSTRACT

A sulfidable catalyst containing at least one metal or metal oxide is sulfided under aqueous conditions.

The present application claims the benefit of pending U.S. Provisional Patent Application Ser. No. 61/496,649, filed Jun. 14, 2011 the entire disclosure of which is hereby incorporated by reference.

### FIELD OF THE INVENTION

The invention relates to sufiding a sulfidable cataslyt containing metal and/or metal oxide under aqueous conditions suitable for use in a biomass process.

### BACKGROUND OF THE INVENTION

A significant amount of attention has been placed on developing new technologies for providing energy from resources other than fossil fuels. Biomass is a resource that shows promise as a fossil fuel alternative. As opposed to fossil fuel, biomass is also renewable.

In processing biomass to produce various renewable fuels, various catalysts are used. However, these catalysts are used in the presence of moisture or in aqueous phase due to the water in the biomass, thus different process conditions exists for biomass processing compared to petroleum refining.

### SUMMARY OF THE INVENTION

Therefore, there is a need to develop a process for catalyst activation suitable for biomass process.

In an embodiment, a process for sulfiding a sulfidable catalyst containing at least one metal or metal oxide under aqueous conditions is provided, comprising: (i) treating said catalyst with an aqueous solution containing at least one water soluble sulfur-containing compound having a solubility of at least 0.2 weight percent, based on aqueous solution to provide a treated catalyst; (b) heating said treated catalyst in the presence of hydrogen at a temperature in the range of about 150° C. to about 550° C.

The method is particularly suitable for application to hydrogenolysis catalysts used in a biomass process. The method is further suitable for in-situ activation of catalysts under aqueous conditions for a biomass process.

The features and advantages of the invention will be apparent to those skilled in the art. While numerous changes may be made by those skilled in the art, such changes are within the spirit of the invention.

### BRIEF DESCRIPTION OF THE DRAWING

The drawing illustrates certain aspects of some of the embodiments of the invention, and should not be used to limit or define the invention.

FIG. 1 is a process flow diagram of one embodiment to implement the aqueous catalyst sulfiding process of this invention.

### DETAILED DESCRIPTION OF THE INVENTION

The invention relates to a process for catalyst activation/sulfiding suitable for a biomass to liquid fuels process. The catalysts referred to herein as “sulfidable metal oxide catalysts(s)” can be catalyst precursors that are used as actual catalyst while in the sulfide form and not in the oxide form. While reference is made to metal oxide catalyst(s), it is understood that while the normal catalyst preparative techniques will produce metal oxide(s), it is possible to utilize special preparative techniques to produce the catalytic metals in a reduced form, such as the zero valent state. Since metals in the zero valent state will be sulfided as well as the oxides when subjected to sulfiding conditions, catalysts containing such sulfidable metals even in reduced or zero valent states will be considered for the purposes of this invention as a sulfidable metal oxide catalyst(s). Further, since the preparative technique of the instant invention can be applied to regenerated catalysts which may have the metal sulfide not completely converted to the oxides, “sulfidable metal oxide catalyst(s)” also refers to these catalysts which have part of their metals in the sulfided state. As used herein the term “hydrocarbon” refers to an organic compound comprising primarily hydrogen and carbon atoms, which is also an unsubstituted hydrocarbon. In certain embodiments, the hydrocarbons of the invention also comprise heteroatoms (i.e., oxygen sulfur, phosphorus, or nitrogen) and thus the term “hydrocarbon” may also include substituted hydrocarbons. The term “soluble carbohydrates” refers to oligosaccharides and monosaccharides that are soluble in the digestive solvent and that can be used as feedstock to the hydrogenolysis reaction (e.g., pentoses and hexoses).

Processing of biomass feeds is challenged by the presence of water in the biomass and need to directly couple biomass hydrolysis to release sugars, and catalytic hydrogenation/hydrogenolysis/hydrodeoxygenation of the sugar, to prevent decomposition to heavy ends (caramel, or tars). A catalyst must be sulfided and activiated in a manner to meet such needs. Therefore, in an embodiment of the invention, a process is provided for sulfiding a sulfidable catalyst containing at least one metal or metal oxide under aqueous conditions. In such method the catalyst is treated with an aqueous solution containing at least one water soluble sulfur-containing compound having a solubility of at least 0.2 weight percent, preferably at least one weight percent to provide a treated catalyst. The description and determination of solubility is provided in references such as Lange's Handbook of Chemistry, J. A. Dean editor, McGraw-Hill, NY (1992) or the CRC Handbook of Chemistry and Physics (e.g. 91^{st} edition 2010-11).

The aqueous solution may contain water soluble alcohol such as ethanol and the treatment with the aqueous solution is conducted as liquid phase.

The thus-treated cataslyt is then heated in the presence of hydrogen at a temperature in the range of about 150° C. to about 550° C., and preferably hydrogen pressure in the range of about 1 bar to about 150 bar, preferably about 200° C. to about 500° C. to activate and at least partially sulfide the catalyst.

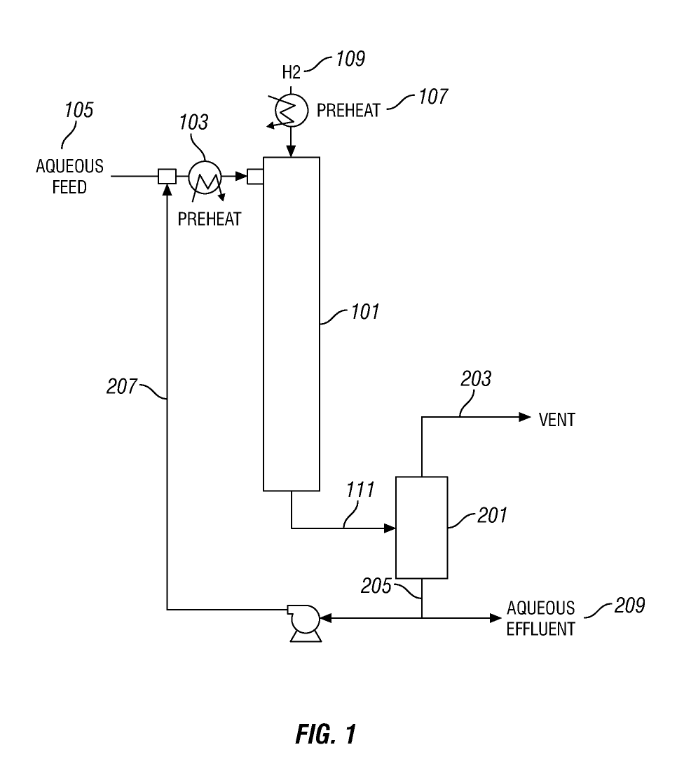

In reference to FIG. 1, in one embodiment of the invention, an aqueous solution 105 containing water and water soluble sulfur-containing compound is fed to the top of catalyst bed 101 through an optional preheater 103. The catalyst bed is also fed hydrogen 109 through an optional preheater 107. Both hydrogen 109 and aqueous solution 105 flow downflow through the bed, to contact catalyst. The outlet of the bed 111 is routed to gas-liquid separator 201, where excess hydrogen, and any H₂S generated is vented 203. Liquid bottoms 205 from the separator may be optionally recycled 207 to the top of the bed. A liquid aqueous effluent 209 is produced. In another embodiment, rather than providing a separate H₂ stream, H₂S may be generated in situ e.g. by addition of an acid to an H₂S-derived salt, such as NaHS. Separate addition of acid stream and NaHS stream to the catalyst bed, will result in production of H₂S in the catalyst bed, which can be used for activation of the catalyst. NaHS may be conveniently added as the sulfur-containing compound in the aqueous solution. Metal or metal oxide comprised in the sulfidable catalyst are typically at least one of groups 6, 8, 9, and/or 10 metals (IUPAC) which maybe a mixture thereof, typically in the amount in the range of 0.5 wt % to 20 wt % based on metal oxide content. Examples of metal or metal oxide include Mo, W, Fe, Co, Ni and mixtures thereof. The metal or metal oxide maybe incorporated into or loaded on a support material.

The method is particularly suitable for application to hydrogenolysis catalysts used in a biomass process. In a copending application filed on the same day by Powell and Smegal, a method of producing liquid fuel using a poison tolerant sulfided hydrogenloysis catalyst is described. In one embodiment of the process a pretreated biomass is contacted with hydrogen in the presence of a supported hydrogenolysis catalyst containing sulfur (as sulfide), and metal/metal oxides/metal sulfides (i) Mo or W, and (ii) Co and/or Ni incorporated into a suitable support to form a plurality of oxygenated intermediates that is further processed to form a liquid fuel.

In one embodiment, the sulfidable catalyst may include a support material that has incorporated therein or is loaded with a metal component, which is or can be converted to a metal compound that has activity towards the catalytic hydrogenolysis of soluble carbonydrates. The support material can comprise any suitable inorganic oxide material that is typically used to carry catalytically active metal components. Examples of possible useful inorganic oxide materials include alumina, silica, silica-alumina, magnesia, zirconia, boria, titania and mixtures of any two or more of such inorganic oxides. The preferred inorganic oxides for use in the formation of the support material are alumina, silica, silica-alumina and mixtures thereof. Most preferred, however, is alumina.

The metal component of the sulfidable catalyst may be incorporated into the support material by any suitable method or means that provides the support material that is loaded with an active metal precursor, thus, the composition includes the support material and a metal component. One method of incorporating the metal component into the support material, includes, for example, co-mulling the support material with the active metal or metal precursor to yield a co-mulled mixture of the two components. Or, another method includes the co-precipitation of the support material and metal component to form a co-precipitated mixture of the support material and metal component. Or, in a preferred method, the support material is impregnated with the metal component using any of the known impregnation methods such as incipient wetness to incorporate the metal component into the support material.

When using the impregnation method to incorporate the metal component into the support material, it is preferred for the support material to be formed into a shaped particle comprising an inorganic oxide material and thereafter loaded with an active metal precursor, preferably, by the impregnation of the shaped particle with an aqueous solution of a metal salt to give the support material containing a metal of a metal salt solution. To form the shaped particle, the inorganic oxide material, which preferably is in powder form, is mixed with water and, if desired or needed, a peptizing agent and/or a binder to form a mixture that can be shaped into an agglomerate. It is desirable for the mixture to be in the form of an extrudable paste suitable for extrusion into extrudate particles, which may be of various shapes such as cylinders, trilobes, etc. and nominal sizes such as 1/16″, ⅛″, 3/16″, etc. The support material of the inventive composition, thus, preferably, is a shaped particle comprising an inorganic oxide material.

The shaped particle is then dried under standard drying conditions that can include a drying temperature in the range of from about 50° C. to about 200° C., preferably, from about 75° C. to about 175° C., and, most preferably, from about 90° C. to about 150° C. After drying, the shaped particle is calcined under standard calcination conditions that can include a calcination temperature in the range of from about 250° C. to about 900° C., preferably, from about 300° C. to about 800° C., and, most preferably, from about 350° C. to about 600° C.

The calcined shaped particle can have a surface area (determined by the BET method employing N₂, ASTM test method D 3037) that is in the range of from about 50 m²/g to about 450 m²/g, preferably from about 75 m²/g to about 400 m²/g, and, most preferably, from about 100 m²/g to about 350 m²/g. The mean pore diameter in angstroms (Å) of the calcined shaped particle is in the range of from about 50 to about 200, preferably, from about 70 to about 150, and, most preferably, from about 75 to about 125.

The pore volume of the calcined shaped particle is in the range of from about 0.5 cc/g to about 1.1 cc/g, preferably, from about 0.6 cc/g to about 1.0 cc/g, and, most preferably, from about 0.7 to about 0.9 cc/g. Less than ten percent (10%) of the total pore volume of the calcined shaped particle is contained in the pores having a pore diameter greater than about 350 Å, preferably, less than about 7.5% of the total pore volume of the calcined shaped particle is contained in the pores having a pore diameter greater than about 350 Å, and, most preferably, less than about 5%.

The references herein to the pore size distribution and pore volume of the calcined shaped particle are to those properties as determined by mercury intrusion porosimetry, ASTM test method D 4284. The measurement of the pore size distribution of the calcined shaped particle is by any suitable measurement instrument using a contact angle of 140° with a mercury surface tension of 474 dyne/cm at 25° C.

In one embodiment, the calcined shaped particle is impregnated in one or more impregnation steps with a metal component using one or more aqueous solutions containing at least one metal salt wherein the metal compound of the metal salt solution is an active metal or active metal precursor. In one embodiment, the metal elements may be molybdenum (Mo), tungsten (W), cobalt (Co) and/or nickel (Ni). Phosphorous (P) can also be a desired metal component. For Co and Ni, the metal salts include metal acetates, formats, citrates, oxides, hydroxides, carbonates, nitrates, sulfates, and two or more thereof. The preferred metal salts are metal nitrates, for example, such as nitrates of nickel or cobalt, or both. For Mo, the metal salts include metal oxides or sulfides. Preferred are salts containing the Mo and ammonium ion, such as ammonium heptamolybdate and ammonium dimolybdate.

The concentration of the metal compounds in the impregnation solution is selected so as to provide the desired metal content in the final composition of the hydrogenolysis catalyst taking into consideration the pore volume of the support material into which the aqueous solution is to be impregnated. Typically, the concentration of metal compound in the impregnation solution is in the range of from 0.01 to 100 moles per liter.

Cobalt, nickel, or combination thereof can be present in the support material having a metal component incorporated therein in an amount in the range of from about 0.5 wt. % to about 20 wt. %, preferably from about 1 wt. % to about 15 wt. %, and, most preferably, from about 2 wt. % to about 12 wt. %, based on metals components (i) and (ii) as metal oxide form; and the Molybdenum can be present in the support material having a metal component incorporated therein in an amount in the range of from about 2 wt. % to about 50 wt. %, preferably from about 5 wt. % to about 40 wt. %, and, most preferably, from about 12 wt. % to about 30 wt. %, based on metals components (i) and (ii) as metal oxide form. The above-referenced weight percents are based upon the quantity of elemental metal present relative to the weight of dry support material regardless of the actual form of the metal component.

The sulfidable catalyst may be sulfided and activated according to the method of the invention. The sulfidable catalyst may be treated prior to its loading into a reactor vessel or system for its use as hydrogenolysis catalyst or may be sulfided, in situ, in the reactor.

Examples of the sulfur-containing compound may be a single compound or mixture of compounds. An example of the sulfur-containing compound may be sodium sulfide, sodium hydrogen sulfide, dimethylsulfoxide (DMSO), sulfur-containing amino acids such as Cysteine or Methionine, and sulfur containing by-products of a biomass digestion process such as methyl mercaptan, dimethyl sulfide, dimethyldisulfide, and other reduced sulfur compounds present in black liquor from pulping of biomass, as described by Zhu et al, Environ. Sci. Technol. 2002, 36, 2269-2272.

In an embodiment using sodium hydrogen sulfide or other reduced sulfides, further hydrogen source may not be necessary in the subsequent step due to self generation of hydrogen sulfide via reaction with acids present in the media, producing hydrogen sulfide which is effective in sulfiding the metal oxide catalyst.

Hydrogen sulfide may also be generated by contacting the catalyst with an organosulfur agent in the presence of hydrogen gas. Dimethylsulfide, methyl mercaptan, dimethyl disulfide and dimethylsulfoxide (DMSO) are examples. DMSO is preferred due to low odor/toxicity, ease of handling, lower decomposition temperature under sulfiding conditions and compatibility with aqueous medium. The organosulfur agents decompose over the catalyst under hydrogen atmosphere to release H₂S which then acts to sulfide the catalyst. In the case of DMSO or sodium hydrogen sulfide, the sulfiding may be carried out in aqueous solution.

Sulfur containing by-product may be obtained from the sulfur containing compounds in the biomass generated during the biomass digestion process. Such process may include Kraft process (and Kraft-like process) typically used in paper mills generating black liquor or green liquor that contains sodium sulfide, sodium hydrogen sulfide, and organic sulfide species that may be used in the process of the invention. Production of such sulfur containing liquor is further described in literature such as Handbook for Pulp & Paper Technologists, published in 2002 by Angus Wilde Publications Inc., Vancouver, B.C.). Suitable aqueous sulfiding solution is one that contains an excess of sulfur vs stoichiomitric, capable of reacting with the metal components of the catalyst to completely displace the oxygens present prior to sulfiding. Stoichiometric requirements entail 1-2 sulfur atoms per metal atom for Group VIII metals, and up to 4 atoms of sulfur per mole of metal for Group VIA metals. Suitable sulfurization treatment conditions are those which provide for the conversion of the active metal components of the precursor hydrgenolysis catalyst to their sulfided form. Typically, the sulfiding temperature at which the precursor hydrgenolysis catalyst is contacted with the sulfur compound is in the range of from about 150° C. to about 450° C., preferably, from about 175° C. to about 425° C., and, most preferably, from about 200° C. to about 400° C.

The aqueous sulfiding method of this invention allows the hydrogenolysis of biomass to be started up conveniently in the reactor and may use the feedstock containing water in the reactor for sulfiding and activation. Thus, an embodiment of the invention relates to an improved hydrogenolysis process which comprises contacting at hydrogenolysis conditions a bio-based feedstock with the hydrogenolysis catalyst which has been sulfieded according to the methods taught herein in the presence of hydrogen.

When using a soluble carbohydrate feedstock as the aqueous solution. that is used to treat the sulfidable catalyst to sulfide, the sulfurization conditions can be the same as the process conditions under which the hydrogenolysis is performed. The sulfiding pressure generally can be in the range of from about 1 bar to about 70 bar, preferably, from about 1.5 bar to about 55 bar, and, most preferably, from about 2 bar to about 35 bar. The resulting active catalyst typically has incorporated therein sulfur content in an amount in the range of from about 0.1 wt. % to about 40 wt. %, preferably from about 1 wt. % to about 30 wt. %, and, most preferably, from about 3 wt. % to about 24 wt. %, based on metals components (i) and (ii) as metal oxide form.

The conditions for which to carry out the hydrogenolysis reaction will vary based on the type of biomass starting material and the desired products (e.g. gasoline or diesel). One of ordinary skill in the art, with the benefit of this disclosure, will recognize the appropriate conditions to use to carry out the reaction. In general, the hydrogenolysis reaction is conducted at temperatures in the range of 80° C. to 300° C., and preferably of 170° C. to 300° C., and most preferably of 180° C. to 260° C.

In an embodiment, the hydrogenolysis reaction is conducted in the presence of a buffer to obtain a pH between about 5 and 9. In another embodiment, the hydrogenlysis is conducted under fully basic conditions at a pH of between 8 to 13, and preferably at a pH of 10 to 12. In an embodiment, the hydrogenolysis reaction is conducted at pressures in a range between 0.5 bar and 200 bar, and preferably in a range between 15 bar and 150 bar, and even more preferably between 50 bar and 110.

The hydrogen used can include external hydrogen, recycled hydrogen, in situ generated hydrogen, and any combination thereof.

The oxygenated intermediates can be processed to produce a fuel blend in one or more processing reactions. In an embodiment, a condensation reaction can be used along with other reactions to generate a fuel blend and may be catalyzed by a catalyst comprising acid or basic functional sites, or both. In general, without being limited to any particular theory, it is believed that the basic condensation reactions generally consist of a series of steps involving: (1) an optional dehydrogenation reaction; (2) an optional dehydration reaction that may be acid catalyzed; (3) an aldol condensation reaction; (4) an optional ketonization reaction; (5) an optional furanic ring opening reaction; (6) hydrogenation of the resulting condensation products to form a C4+ hydrocarbon; and (7) any combination thereof. Acid catalyzed condensations may similarly entail optional hydrogenation or dehydrogenation reactions, dehydration, and oligomerization reactions. Additional polishing reactions may also be used to conform the product to a specific fuel standard, including reactions conducted in the presence of hydrogen and a hydrogenation catalyst to remove functional groups from final fuel product. A catalyst comprising a basic functional site, both an acid and a basic functional site, and optionally comprising a metal function, may be used to effect the condensation reaction

To facilitate a better understanding of the present invention, the following examples of certain aspects of some embodiments are given. In no way should the following examples be read to limit, or define, the entire scope of the invention.

### EXAMPLES

Catalyst activation and sulfiding studies were conducted in a Parr5000 Hastelloy multireactor comprising 6×75-milliliter reactors operated in parallel at pressures up to 135 bar, and temperatures up to 275° C., stirred by magnetic stir bar. Alternate studies were conducted in 100-ml Parr4750 reactors, with mixing by top-driven stir shaft impeller, also capable of 135 bar and 275° C.

Reaction samples were analyzed for sugar, polyol, and organic acids using an HPLC method entailing a Bio-Rad Aminex HPX-87H column (300 mm×7.8 mm) operated at 0.6 ml/minute of a mobile phase of 5 mM sulfuric acid in water, at an oven temperature of 30° C., a run time of 70 minutes, and both RI and UV (320 nm) detectors.

Product formation (mono-oxygenates, diols, alkanes, acids) were monitored via a gas chromatographic (GC) method “DB5-ox”, entailing a 60-m×0.32 mm ID DB-5 column of 1 um thickness, with 50:1 split ratio, 2 ml/min helium flow, and column oven at 40° C. for 8 minutes, followed by ramp to 285° C. at 10° C./min, and a hold time of 53.5 minutes. Injector temperature was set at 250° C., and detector temperature at 300° C.

### Examples 1& 2

### Aqueous NaHS Activation

For example 1, a Parr 5000 reactor was charged with 0.498 grams of nickel-promoted cobalt oxide—molybdate/alumina catalyst (DC-2533 from Criterion Catalyst & Technologies L.P.), and 0.602 grams of sodium hydrogen sulfide (NaHS) from Sigma-Aldrich Co. A second reactor (example 2) was charged with 0.503 grams of the same nickel-promoted cobalt oxide—molybdate/alumina catalyst, with no NaHS. 20.0 milliliters of a solution of 20% by weight glycerol in deionized water were added to each reactor, before pressuring to 52 bar with H₂, and heating to 240° C. for 20 hours. Concentrations of reaction product were determined by DB5-ox GC method, and HPLC analysis.

Conversion of glycerol for example 1 (with added sodium hydrogen sulfide) corresponded to a first order rate constant of 2.7 l/h/wt-fraction catalyst, with 1,2-propylene glycol the principal product detected. Glycerol conversion for example 2 (no sodium hydrogen sulfide) corresponded to a rate of only 0.1 l/h/wt-fraction catalyst, or less than 20 times the activity of example 1.

This example shows activation of a nickel, cobalt, and molybdenum oxide catalyst via addition of an aqueous solution of a reduced sulfur compound NaHS.

### Examples 3 & 4

0.5 grams of nickel-promoted cobalt oxide-molybdate/alumina catalyst were treated with 25-grams of 10% cysteine in deionized water, overnight at 240 C. 0.26 grams of the resulting treated catalyst were charged with a mixture of 25% glycerol and 25% sorbitol in deionized water, and 60 psi of H₂, before heating to 250 C for 5 hours. HPLC and DB %-ox analysis indicated conversion of glycerol to propylene glycol and mono-oxygenates at a rate of 2.2 l/h/wt. A companion run (example 4) using fresh nickel-promoted cobalt-oxide molybdate/alumina catalyst which had not been subjected to preactivation with cysteine, gave no measurable conversion of glycerol. This example demonstrates the ability of cysteine to active a cobalt molybdate catalyst to effect hydrogenolysis and hydro-deoxygenation reactions.

### Examples 5 & 6

0.4 grams of a nickel oxide, molybdenum trioxide on a-alumina catalyst described in U.S. Pat. No. 7,381,852 were charged with 20 grams of 13.7% glycerol and 7.1% sorbitol in deionized water to a Parr 5000 reactor (Example 5). This example was repeated with addition of 0.5 grams of cysteine to a second reactor (Example 6). Both reactors were pressured to 52 bari H₂, and heated to 240° C. for 7.5 hours. Glycerol conversion corresponded to a rate of 3.6 l/h/wt-catalyst for Example 23 (no cysteine addition), but was increased to a rate of 13.3 l/h/wt-catalyst for Example 24 with added cysteine. These examples show the ability of cysteine (an N,S-amino acid) to activate a NiO/MoO₃ catalyst, to enhance rates of hydrogenolysis and hydro-deoxygenation.

### Examples 7-9

For example 7, a sample of DC2533 nickel-promoted cobalt oxide-molydate/alumina catalyst was fully sulfided via treatment with di-tert-nonylpolysulfide (TNPS) as described in Example 3 of US2006/0060510. 0.437 grams of the fully sulfided catalyst were charged with 23.2 grams of a solution of 25 wt % glycerol in deionized water, to a Parr 5000 reactor. H₂ was added at 52 bar, and the reactor was heated for 23 hours at 210° C. Unconverted glycerol was measured by HPLC analysis, and corresponded to a reaction rate of 2.2 l/h/weight-fraction of catalyst.

Example 8, 0.45 grams of untreated DC2533 catalyst were charged with 23.6 grams of the 25 wt % glycerol solution. The reactor was also heated under 52 bar of H₂ for 23 hours at 210° C., to match conditions deployed in Example 7. Glycerol conversion was undetectable, indicating a complete lack of reaction in the absence of activation of catalyst.

For example 9, the 0.44 grams of the untreated DC2533 catalyst were charged with 24.3 grams of 25 wt % glycerol solution, with addition of 1.006 grams of NaHS. The reactor was also heated under 52 bar of H₂ for 23 hours at 210° C., to match conditions deployed in examples 7 & 8. Conversion of glycerol corresponded to an apparent first-order reaction rate of 2.2 l/h/wt-fraction of catalyst, or identical to that measured for the catalyst fully sulfided in organic solution, in example 7.

These results show that treatment with a sulfiding agent is required for activity under the conditions employed, and that sulfiding with NaHS in aqueous solution is effective in activing the catalyst for conversion of glycerol via hydrogenolysis reactions.

### Example 10

2 grams of a crushed cobalt oxide-molybdate/alumina catalyst were sulfided via treatment with 20 g of a 50% wt solution of dimethylsulfoxide (DMSO) in DI water. The 100 ml Parr reactor was pressurized with 15 bar H₂, then the temperature was slowly ramped to 335 deg C. over 10 hrs and held for 2 hrs. After this, the reactor was cooled and the headspace swept with nitrogen into caustic to remove any residual H₂S. Sulfided catalyst was collected by filtration and transferred to a dry box. A Parr 5000 reactor was charged with 0.307 grams of sulfided catalyst, 20.1 grams of 25% ethanol in deionied water solvent, 0.408 grams of glycerol, and 0.055 grams of sodium carbonate as buffer. 51 bar of H₂ were added, and the reactor was heated for 5 hours at 240° C. to assess conversion. GC analysis revealed 9.9% conversion of glycerol to 1,2-propylene glycol, compared with less than 1% for a comparison run with unsulfided catalyst. This example demonstrates that DMSO can sulfide and activate cobalt molybdate catalyst under aqueous conditions.

What is claimed is:

1. A process for sulfiding a sulfidable catalyst containing at least one metal or metal oxide under aqueous conditions comprising: (i) treating said catalyst with an aqueous solution containing at least one water soluble sulfur-containing compound having a solubility of at least 0.2 wt %, based on the aqueous solution to provide a treated catalyst; (b) heating said treated catalyst in the presence of hydrogen at a temperature in the range of about 150° C. to about 550° C.

2. The process of claim 1 wherein the sulfur-containing compound is sodium hydrogen sulfide.

3. The process of claim 1 wherein the sulfur-containing compound is sulfur containing amino acid.

4. The process of claim 1 wherein the sulfur-containing compound is a by-product of a biomass digestion process.

5. The process of claim 2 wherein the catalyst is supported catalyst containing at least one metal/metal oxide of groups 6, 8, 9, or 10.

6. The process of claim 5 wherein the catalyst is a supported hydrogenolysis catalyst containing (a) Mo or W, and (b) Co, Ni or mixture thereof, incorporated into a suitable support.

7. The process of claim 5 wherein the support is an inorganic oxide material.

8. The process of claim 3 wherein the catalyst is supported catalyst containing at least one metal/metal oxide of groups 6, 8, 9, or 10.

9. The process of claim 8 wherein the catalyst is a supported hydrogenolysis catalyst containing (a) Mo or W, and (b) Co, Ni or mixture thereof, incorporated into a suitable support.

10. The process of claim 8 wherein the support is an inorganic oxide material.

11. The process of claim 4 wherein the catalyst is supported catalyst containing at least one metal/metal oxide of groups 6, 8, 9, or 10.

12. The process of claim 11 wherein the catalyst is a supported hydrogenolysis catalyst containing (a) Mo or W, and (b) Co, Ni or mixture thereof, incorporated into a suitable support.

13. The process of claim 11 wherein the support is an inorganic oxide material.

14. The process of claim 4 wherein the sulfur-containing compound is black liquor.

15. The process of claim 1 wherein the sulfur-containing compound in the aqueous solution is dimethylsulfoxide.

16. The process of claim 15 wherein the catalyst is supported catalyst containing at least one metal/metal oxide of groups 6, 8, 9, or 10.

17. The process of claim 15 wherein the catalyst is a supported hydrogenolysis catalyst containing (a) Mo or W, and (b) Co, Ni or mixture thereof, incorporated into a suitable support.

18. The process of claim 16 wherein the support is an inorganic oxide material.
